(19) United States
(12) Patent Application Publication
(10) Pub. No.: US 2026/0095781 A1
(43) Pub. Date: Apr. 2, 2026

(54) LOW OVERHEAD RECONFIGURATION

(71) Applicant: InterDigital Patent Holdings, Inc., Wilmington, DE (US)

(72) Inventors: Martino M. Freda, Laval (CA); Brian Martin, Farnham (GB); Paul Marinier, Brossard (CA); Oumer Teyeb, Montreal (CA); Keiichi Kubota, Tokyo (JP); Dylan Watts, Montreal (CA); Benoit Pelletier, Roxboro (CA)

(73) Assignee: InterDigital Patent Holdings, Inc., Wilmington, DE (US)

(21) Appl. No.: 18/901,737

(22) Filed: Sep. 30, 2024

(51) Int. Cl. H04W 24/02; H04B 7/06; H04W 8/22; H04W 76/20

(52) U.S. Cl. CPC H04W 24/02; H04B 7/0626; H04W 8/22; H04W 76/20

(57) ABSTRACT

Systems, methods, and instrumentalities are described herein associated with low overhead reconfiguration. For example, cell configuration may be associated with low overhead reconfiguration. Low overhead reconfiguration may include performing reconfiguration based on one or more of a cell type, a wireless transmit/receive unit (WTRU) profile, a parameter mask, or stored candidate cell configuration information.

### BACKGROUND

Mobile communications using wireless communication continue to evolve. A fifth generation may be referred to as 5G. A previous (legacy) generation of mobile communication for example, may be fourth generation (4G) long term evolution (LTE).

### SUMMARY

Systems, methods, and instrumentalities are described herein associated with low overhead reconfiguration. For example, cell configuration may be associated with low overhead reconfiguration. Low overhead reconfiguration may include performing reconfiguration based on one or more of a cell type, a wireless transmit/receive unit (WTRU) profile, a parameter mask, or stored candidate cell configuration information.

The WTRU may determine cell configuration, for example, based on a cell type, a WTRU profile, and a parameter mask. The WTRU may determine a WTRU profile, a cell type associated with a target cell, and/or a parameter mask (e.g., bit mask). The WTRU may determine the WTRU profile based on one or more of data available for transmission, a cell measurement (e.g., reference signal received power (RSRP)), a WTRU capability, a WTRU speed, or received configuration information indicating the WTRU profile. The WTRU may determine the parameter mask based on one or more of a measurement, a WTRU speed, a WTRU location, an active service associated with the WTRU, a quality of service (QoS) flow associated with the WTRU, or a received indication. The parameter mask may include a bit mask. The bit mask may indicate whether to determine cell configuration (e.g., parameter value) based on a reference configuration or based on a combination of the WTRU profile and the cell type. The WTRU may determine the cell type based on one or more of an indicated value, an identity associated with target cell system information, a transmission property associated with the target cell, a transmission of a signal, or a determination of an absence of the signal. For example, the WTRU may receive (e.g., read) a SIB associated with the target cell. The SIB associated with the target cell may indicate the parameter mask and/or the cell type associated with the target cell. The WTRU may determine a parameter value based on the WTRU profile, the parameter mask, and the cell type. The WTRU may determine the parameter value based on the WTRU profile, the parameter mask, and/or the cell type, for example, on a condition that the parameter mask indicates to determine the parameter value based on a combination of the WTRU profile and the cell type. The parameter value may be further determined based on the configuration information (e.g., determining the parameter value based on the associated cell type and WTRU profile pair indicated in the configuration information). The WTRU may initiate a transmission and/or a reception associated with the target cell. The WTRU may initiate the transmission/reception associated with the target cell using the determined parameter value.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Other examples of this aspect include corresponding computer systems, apparatus, and computer programs recorded on one or more computer storage devices, each configured to perform the actions of the methods.

Each feature disclosed anywhere herein is described, and may be implemented, separately/individually and in any combination with any other feature disclosed herein and/or with any feature(s) disclosed elsewhere that may be impliedly or expressly referenced herein or may otherwise fall within the scope of the subject matter disclosed herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a block diagram illustrating an example solution associated with low overhead reconfiguration.

### DETAILED DESCRIPTION

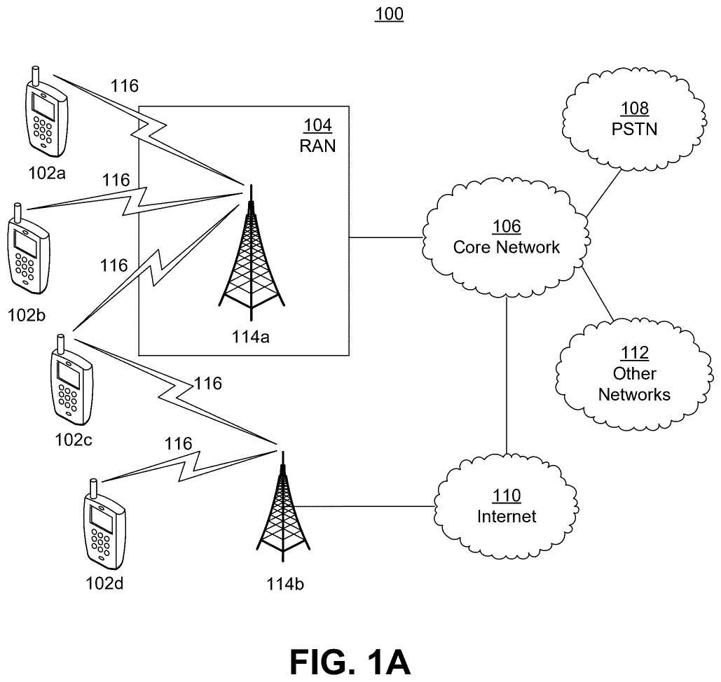

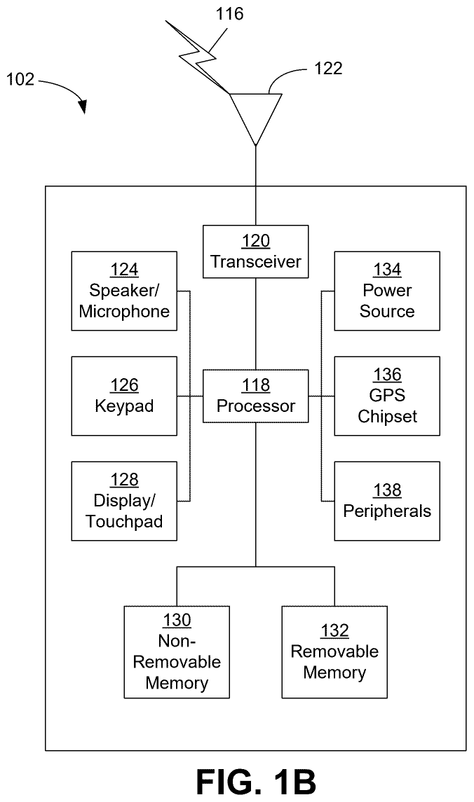

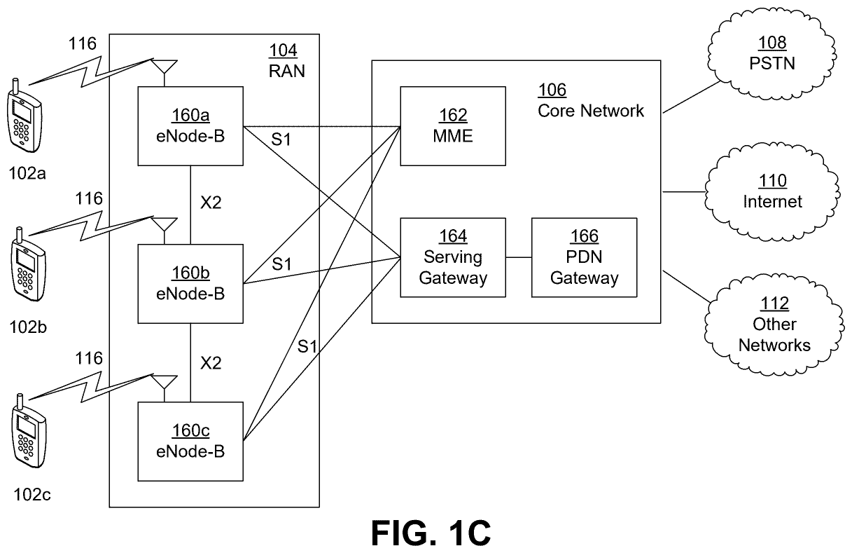

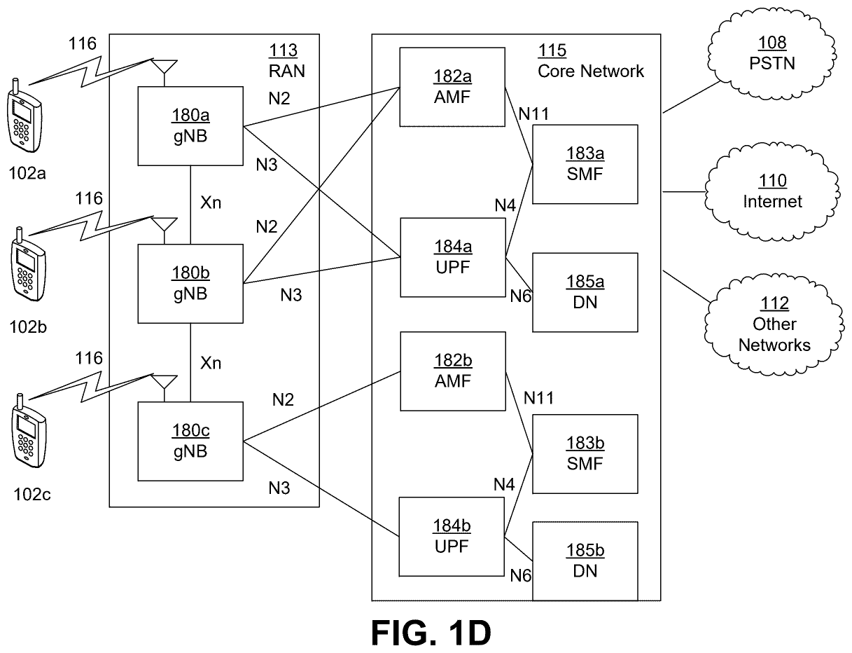

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

Systems, methods, and instrumentalities are described herein associated with low overhead reconfiguration. For example, cell configuration may be associated with low overhead reconfiguration. Low overhead reconfiguration may include performing reconfiguration based on one or more of a cell type, a wireless transmit/receive unit (WTRU) profile, a parameter mask, or stored candidate cell configuration information.

A WTRU may receive configuration information indicating (e.g., be (pre)configured with) a table of cell-type.

A WTRU may receive configuration information indicating (e.g., be (pre)configured with) a set of WTRU profiles (e.g., profiles for determining the radio resource control (RRC) configuration).

A WTRU may determine the value of a configuration parameter, for example, based on profile and/or cell type.

A WTRU may determine the value of a configuration parameter, for example, based on a cell ID or transformation information.

A WTRU may request configuration information associated with a candidate cell (e.g., a WTRU may request configuration information applicable to a candidate cell (e.g., a mobility cell)).

A WTRU may determine a configuration mechanism for a configuration parameter.

A WTRU may signal the selected profile.

Reconfiguration (e.g., in NR) may be described herein. Mobility (e.g., in NR) may be based on RRC reconfiguration. In examples (e.g., RRC reconfiguration), a WTRU may receive a message (e.g., an RRC message) with a configuration information (e.g., a full configuration) of (e.g., all possible) parameters (e.g., RRC parameters), or a delta configuration which changes (e.g., only certain) parameters (e.g., RRC parameters) to be changed, leaving the parameters not included to be unchanged compared to the currently stored/applied configuration.

Mobility (e.g., in NR) may be described. In handover, a WTRU may receive configuration information (e.g., an RRC configuration) of the target cell in the handover command. The configuration information (e.g., RRC configuration) may include a full configuration or a delta configuration. The configuration information may represent (e.g., indicate) the WTRU's configuration to use in the target cell.

L1/L2 triggered mobility (LTM) may be used, for example, to reduce the latency associated with layer 3 (L3) mobility. In LTM, the WTRU may receive a list of candidate cell configurations in advance (e.g., before the handover). The cell switch command may be issued with a cell ID, and the WTRU may (e.g., simply) uses the cell configuration it has stored for the respective cell.

Initial mobility (e.g., 5G (e.g., 5G NR) mobility) and reconfiguration may be based on a configuration technique. A WTRU may be configured (e.g., via RRC signaling) with a set of parameter(s) that may control its behavior at a (e.g., each) layer of the protocol stack (e.g., physical layer (PHY) RRC parameters, MAC layer RRC parameters, and/or the like). Mobility may be achieved by providing an RRC reconfiguration to the WTRU in a handover command (e.g., which may correspond to another (e.g., the new) configuration to be used by the WTRU in the target cell). Delta configuration (e.g., where (e.g., only) the modified RRC parameters are provided) may be used to reduce the overhead of providing a list of RRC parameters (e.g., the full list of RRC parameters).

Handover latency reduction techniques may be used (e.g., built into NR) based on using an RRC configuration architecture, for example, due to requirements (e.g., new 5G requirements) of lower latency for mobility and/or a network architecture (e.g., new network architecture) of CU/DU splitting,. LTM mobility may replace L3 mobility, for example, by using lower layer measurements and signaling (e.g., MAC signaling) to limit mobility decisions (e.g., the majority of mobility decisions) within the DU and remove the need for sending/receiving RRC signaling to the WTRU at the HO command. Replacing L3 mobility with LTM mobility may be performed while maintaining the RRC architecture (e.g., LTE architecture, which may be a baseline for NR). In examples, the WTRU may (e.g., need to) store a previously sent set of RRC configurations of the candidates.

The scalability of such a solution may be an issue. A WTRU may not support more than 8 cells in an LTM area (e.g., due to the large amount of configuration information that may (e.g., need to) be stored for a (e.g., each) of the cells). This issue may impact the efficiency of WTRU reconfiguration (e.g., in general). For example, if the cell performs (e.g., needs to perform) frequent reconfiguration at the WTRU, these reconfigurations may come at a significant signaling cost.

Mobility at lower layers (e.g., which may be a concept introduced with LTM), may be used (e.g., likely to be re-used in 6G) given the advantages of the CU/DU split architecture and smaller cells (e.g., requiring faster HO). The design of the RRC architecture with respect to mobility that may be (e.g., currently) used in LTM (which may be associated with LTE) may not be well tailored to it for one or more of the following reasons.

The WTRU may (e.g., need to) store multiple RRC candidates (e.g., which may (e.g., need to) be signaled via a typically large RRC message), even though the WTRU may not (e.g., may never need to) use the configuration of (e.g., some of) these RRC messages (e.g., the WTRU may not be handed over to those cells).

The number of RRC configuration parameters may become (e.g., extremely) large, for example, with the introduction of beams and beam reporting. Cells of a DU or CU (e.g., the same DU or CU) may include a (e.g., very) similar configuration, and the (e.g., main) differences for a WTRU (e.g., with a WTRU capability) may be predicted or derived by the WTRU without explicitly providing a (e.g., every) parameter to the WTRU in an over-the-air message.

A WTRU reconfiguration mechanism that may be tailored to lower-layer mobility and may (e.g., further) reduce the signaling overhead and/or storage requirements may be described.

The WTRU may determine the WTRU's cell configuration based on at least one of a cell type, a WTRU profile, a parameter mask, or a stored set of candidate cell configurations.

A WTRU may transmit a set of WTRU capabilities to the network (e.g., in an RRC message).

The WTRU may receive configuration information (e.g., dedicated RRC configuration information). The configuration information (e.g., dedicated RRC configuration information) may include at least one of an RRC configuration for the WTRU to operate in the cell, an LTM reference configuration, a set of LTM candidate cell configurations, or a WTRU profile (e.g., an value or index).

The WTRU may be preconfigured (e.g., in a specification) with a (e.g., configuration) parameter value (e.g., a CSI configuration, a search space configuration, and/or the like) for a pair of WTRU profile and cell type (e.g., a respective parameter value (e.g., configuration parameter value) for each respective WTRU profile/cell type pair. For example, each parameter value (e.g., configuration parameter value) from a plurality of parameter values in the configuration information is associated with a respective WTRU profile and cell type pair).

A WTRU may receive a mobility command (e.g., via a MAC CE). The mobility command may include a target cell index associated with the candidate target cell.

A WTRU may receive (e.g., read) a SIB (e.g., SIB1) of the target cell. The WTRU may receive a cell type and/or a parameter mask (e.g., the WTRU may receive a SIB that indicates a cell type and/or a parameter mask).

The cell type may be one of a number of pre-specified cell types (e.g., type 1, type 2, and/or the like).

The parameter mask may indicate if/whether a parameter value (e.g., configuration parameter) may be (e.g., if/whether a specific parameter value (e.g., configuration parameter) should be) configured by the reference configuration or configured by the combination of the WTRU profile and cell type. In examples, the use of the parameter mask may resolve (e.g., may be used to resolve) the uncertainty of if/whether the absence of a parameter in delta configuration means to maintain the same value.

For example, a parameter mask may be a bit mask, where a (e.g., each) bit in the mask is associated with a configurable RRC parameter. In examples, if the bit is set to ‘1’, the associated RRC parameter may be configured by a reference configuration (e.g., indicated in the configuration information), otherwise, the associated RRC parameter may be configured by a combination of the WTRU profile and the cell type.

For a configurable RRC parameter (e.g., for each of the configurable RRC parameters), if the configurable RRC parameter is configured by a combination of the WTRU profile and the cell type, the WTRU may apply the preconfigured parameter value for the configurable RRC parameter, otherwise, the WTRU may apply the configuration for the configurable RRC parameter from the stored reference configuration associated with the target cell (e.g., indexed in the MAC CE).

The WTRU may initiate a transmission/reception to the target cell with the applied configuration, for a configurable RRC parameter (e.g., for each of the configurable RRC parameters).

In examples, the WTRU may determine a WTRU profile, a cell type associated with a target cell, and/or a parameter mask (e.g., bit mask). The WTRU may determine the WTRU profile based on one or more of data available for transmission, a cell measurement (e.g., RSRP), a WTRU capability, a WTRU speed, a QoS flow associated with the WTRU, or received configuration information indicating the WTRU profile. The WTRU may determine the parameter mask based on one or more of a measurement, a WTRU speed, a WTRU location, an active service associated with the WTRU, a QoS flow associated with the WTRU, or a received indication. The WTRU may determine the cell type based on one or more of an indicated value, an identity associated with target cell system information, a transmission property associated with the target cell, a transmission of a signal, or a determination of an absence of the signal. For example, the WTRU may receive (e.g., read) a SIB associated with the target cell. The SIB associated with the target cell may indicate the parameter mask and/or the cell type associated with the target cell. The WTRU may determine a parameter based on the WTRU profile, the parameter mask, and the cell type. The WTRU may determine the parameter value based on the WTRU profile, the parameter mask, and/or the cell type, for example, on a condition that the parameter mask indicates to determine the parameter value based on a combination of the WTRU profile and the cell type. The parameter may be further determined based on the configuration information (e.g., determining the parameter based on the associated cell type and WTRU profile pair indicated in the configuration information). The WTRU may initiate a transmission and/or a reception associated with the target cell. The WTRU may initiate the transmission/reception associated with the target cell based on the determined parameter.

A WTRU may be (pre)configured with a table of cell-type(s).

In examples, a WTRU may be configured with a list of cell types. A cell type may be an identifier, a value, a parameter, and/or the like, that is associated with a cell. A cell may be of a type (e.g., a cell may be considered to be of a specific type such as of a first type vs. of a second type).

A table of cell types may be preconfigured in the specification(s). A table of cell types may be provided to the WTRU (e.g., in universal subscriber identity module (USim), or in another similar non-volatile storage at the WTRU). A table of cell types may be configured to the WTRU in dedicated RRC signaling. A table of cell types may be provided in a SIB.

A table of cell types may include an identifier, a value, a parameter, and/or the like. An identifier, a value, a parameter, and/or the like may (e.g., further) be associated with a (e.g., specific) cell by the WTRU, in order to assist the WTRU to determine its own configuration (e.g., if/when operating in that cell).

The cell type may be determined based on an explicit value transmitted by the cell in SIB.

The cell type may be indicated implicitly based on another identity transmitted in the cell's system information. The cell type may be determined by the WTRU based on the WTRU's cell ID (e.g., cell type=cell ID mod N).

The cell type may be determined based on a transmission property of the cell (e.g., such as the pattern or reference signals, synchronization signal blocks (SSBs), and/or the like. The cell type may be determined based on the timing of a message (e.g., such as system information, and/or the like). For example, the WTRU may determine the cell to be of a first type based on receiving a (e.g., specific) pattern of reference signals, or a second type based on a second pattern of reference signals.

The cell type may be determined based on the presence or absence of a (e.g., specific) signal, a reference signal, a SIB type, and/or the like. For example, the WTRU may determine the cell to be of a first cell type or a second cell type based on the presence or absence of a (e.g., specific) SIB.

The WTRU may be (pre)configured with a set of WTRU profiles for determining the RRC configuration.

In examples, a WTRU may be (pre)configured with one or more WTRU profile(s), which may be used to determine its RRC configuration.

A WTRU profile may be an identifier, an enumerated type, an integer, and/or the like, which may identify a (e.g., specific) WTRU type. A WTRU profile may be received from the network, for example, via dedicated signaling. For example, a WTRU may receive its WTRU profile in an RRC message (e.g., an RRC setup message, an RRC resume message, an RRC reconfiguration message, and/or the like). The WTRU may request a profile from the network, e.g., by sending its WTRU capabilities.

In examples, a WTRU may autonomously determine its WTRU profile, for example based on at least one factor, including: data available for transmission, service cell or neighbor cell measurements, WTRU capabilities, or WTRU speed.

A WTRU may autonomously determine its WTRU profile based on data available for transmission and (e.g., any) properties associated with the data (e.g., such as an amount of data buffered, a QoS, a determination of a remaining latency, or active service(s) at the WTRU).

A WTRU may autonomously determine its WTRU profile based on an amount of data buffered. For example, if the amount of data buffered (e.g., possibly for one or more logical channels), is above a threshold, the WTRU may determine it is of a first profile, otherwise, the WTRU may determine it is of a second profile.

A WTRU may autonomously determine its WTRU profile based on QoS flows and/or QoS properties of the QoS flows activated for transmission. For example, if the WTRU has a (e.g., specific) number and/or type of QoS flows active for data transmission, the WTRU may determine it is of a first profile.

A WTRU may autonomously determine its WTRU profile based on (e.g., an instantaneous) determination of a remaining latency (e.g., potentially relative to the data requirements). For example, if the remaining latency budget for data (e.g., some data or a configured amount of data) is less than a threshold, the WTRU may determine it is of a (e.g., specific) profile.

A WTRU may autonomously determine its WTRU profile based on active service(s) at the WTRU.

A WTRU may autonomously determine its WTRU profile based on serving cell or neighbor cell measurements. For example, if the serving cell measurements are within a range of values, the WTRU may determine it is of a (e.g., specific) profile. For example, for a combination (e.g., or ratio) of serving beam versus non-serving beam measurements, the WTRU may determine that it is of a (e.g., specific) profile. For example, the WTRU may determine it is of a (e.g., specific) profile if the number of beams from the serving cell which are measured above a measurement threshold is above a number threshold.

A WTRU may autonomously determine its WTRU profile based on WTRU capabilities. For example, the WTRU may include (e.g., some specified) rules for determining the WTRU profile from the other factors which depends on the WTRU's capabilities.

A WTRU may autonomously determine its WTRU profile based on a WTRU speed.

For example, the WTRU may include (e.g., some specified) rules for determining the WTRU profile from (e.g., other) factor(s) which depend on the WTRU's speed.

The association between the factors and/or associated values and the WTRU profile may be predefined (e.g., in a specification or configuration information). The association may be configured by an RRC message. A configuration may be performed infrequently. The overhead may be limited to the time in which the WTRU first connects to the network and/or reports the capabilities (e.g., when a WTRU performs a configuration).

In examples, the (e.g., specific) value of an RRC parameter may be signaled by the network (e.g., in a MAC CE, or downlink control information (DCI)). In examples, a WTRU may receive (e.g., via RRC signaling) a configuration for a (e.g., specific) parameter (e.g., RLF timers, RLC channel configuration, and/or the like), with a list of values that may be taken by that parameter. The WTRU may receive a MAC CE, where the MAC control element (CE) includes the index in the list of RRC configured values of the value which is configured (e.g., which should be configured). For example, a cell switch signaling (e.g., cell switch MAC CE) may include a value of N for the index, and the WTRU may use the Nth value within the RRC configured list of values of the RLF timer as the configured value.

In examples, the WTRU may receive a profile via signaling (e.g., via a MAC CE). The WTRU profile may be provided explicitly in the MAC CE (e.g., in a cell switch MAC CE), where the signaled profile value in the MAC CE references a (e.g., any) value supported profile value for the WTRUs (e.g., for all WTRUs). A WTRU may self-determine a subset of supported profiles based on the factor(s) (e.g., any of the factors) described herein, in the case of a WTRU autonomous determination. For example, a WTRU may determine a subset of WTRU profiles based on its reported WTRU capabilities. Based on the subset of supported profiles, the WTRU may determine an ordered list of profiles. The WTRU may receive an index (e.g., in a MAC CE or DCI) which selects one of the profiles in the ordered list at the WTRU. The WTRU may determine its parameter configuration based on the determined profile and a table mapping the profile (and possibly a determined cell type) to the actual WTRU configuration. In examples, the WTRU may (e.g., alternatively) be configured (e.g., in RRC signaling) with an allowable set of profiles. Following such RRC signaling, the WTRU may receive dynamic signaling (e.g., MAC CE or DCI) with an index of the profile to be used by the WTRU. The WTRU may determine an RRC configuration parameter based on the determined profile.

A WTRU may determine the value of a parameter (e.g., parameter value, configuration parameter value) based on a profile and/or a cell type.

In examples, a WTRU may determine the value of a parameter (e.g., parameter value, configuration parameter value) based on the WTRU's determined profile and the cell type. The WTRU may be (pre)configured with a table of configuration parameter values (e.g., for a specific parameter) based on a profile and/or a cell type. In examples, a table may be defined in specifications. In examples, a table may be transmitted to the WTRU in RRC signaling. For example, a (e.g., each) parameter may include a parameter-specific table mapping a profile or a cell type to a parameter value (e.g., mapping may be unique). Parameter(s) may be applicable for a (e.g., given) profile and cell type. The WTRU may select a (e.g., one) value of the parameter to use in its configuration (e.g., the WTRU may select a value of a parameter that is applicable for a profile or a cell type).

A WTRU may determine an RLF time (e.g., via RLF timers) based on the profile and cell type.

For example, for a profile “x” and cell type “y”, the WTRU may be preconfigured to use ms200 for the value (e.g., of a T310), n4 for the value (e.g., of a T311), and/or the like. For example, a WTRU may determine the cell type from SIB signaling (e.g., type y), receive the WTRU profile from dedicated signaling (e.g., profile x), and derive the RLF time (e.g., RLF timers) based on a prespecified table.

A WTRU may determine the value of a parameter (e.g., parameter value, configuration parameter value) based on a cell ID and/or transformation information.

In examples, a WTRU may determine its configuration (e.g., possibly for a subset of configuration parameters), based on its current configuration and/or (e.g., some) information indicated in the SIB. For example, information may be a cell type. For example, information may be derived from the cell ID.

RRC parameter(s) may be configured by a first cell (e.g., in RRC signaling to a WTRU). The WTRU may then be configured with a transformation function (e.g., after being configured by the first cell). A transformation function may be specified or configured (e.g., via RRC signaling). A transformation function may include transformation(s) (e.g., a transformation function may include a limited number of possible transformations such as multiply by x, add y, and/or the like). A WTRU may determine which transformation to apply to a (e.g., current) value of a parameter based on an identity in the SIB. For example, a WTRU may be configured with a set of transformation functions in RRC signaling. Configuration information (e.g., specifications) may indicate an indexed number of transformation functions. The WTRU may receive (e.g., via RRC signaling) a list of transformation functions applicable to the WTRU (e.g., as a list of the indices attached to each function in the specification). Finally, the WTRU may determine the transformation function to apply (e.g., during a handover) to one or more parameters based on a value sent by the target cell. The SIB may transmit an index which includes one of the transformation functions configured at the WTRU. The cell switch MAC CE, or the HO (CHO) command may include the index of one of the transformation functions configured at the WTRU.

A WTRU may request configuration information applicable to a candidate (e.g., mobility) cell.

In examples, a WTRU may request configuration or information (e.g., needed) to derive a configuration (e.g., a profile, a cell type, a parameter mask, and/or the like) for a candidate cell. For example, a WTRU may send an RRC message to the source cell, to request a configuration. A WTRU may transmit a request to the candidate cell (e.g., using a RACH transmission). A WTRU may transmit a request for configuration as an system information (SI) request, indicating the cell ID. A WTRU may transmit a MAC CE or a PHY layer channel transmission (e.g., a scheduling request (SR) or physical uplink control channel (PUCCHI) transmission), to request configuration information. For example, a WTRU may be configured with an SR resource. The WTRU may request configuration information (e.g., possibly for a specific cell), by sending an SR. The SR resource may be tied (e.g., by RRC signaling) to a candidate cell (e.g., the SR resource may be further be tied (e.g., by RRC signaling) to a specific candidate cell).

In examples, a WTRU may provide a requested configuration for operation in a (e.g., specific) cell. For example, based on the WTRU's ability to meet a QoS, the WTRU may provide the network with a requested profile or a requested set of configuration values for a subset of parameters.

A WTRU may be configured with events and/or triggers for requesting configuration or profile information. In examples, a WTRU may be configured with a measurement-like event (e.g., event Ax like) for requesting configuration for a candidate cell. In examples, if a candidate cell triggers a measurement event, the WTRU may be allowed to request configuration information for the candidate cell. In examples, a WTRU may be configured with a data-based trigger (e.g., arrival of new data, QoS requirements being met, information from upper layers on requirements, and/or the like), for requesting configuration information for the current cell and/or a candidate cell. For example,, a WTRU may be configured with an events (e.g., a data-based trigger) in order acquire the configuration and/or profile (e.g., needed) for the WTRU to derive the configuration(e.g., if/when needed).

A requested configuration may be associated with a configured or defined lifetime. For example, a WTRU may request a profile, cell type, and/or the like, from the network. The information provided may be valid for a defined or configured time period. Based on expiry of the time period, if the WTRU did not apply the configuration or the configuration associated with the profile, the WTRU may release the profile information. A time-based release may allow the network to re-use an index or a value associated with a profile if/when the index or the value is unused.

Coexistence between configuration mechanisms may be described.

A WTRU may determine a configuration mechanism for a parameter value (e.g., configuration parameter value).

In examples, a WTRU may be configured (e.g., for different parameter values (e.g., configuration parameters)), using mechanism(s). A WTRU may be configured by traditional RRC (e.g., delta) signaling for a first set of parameters. A WTRU may be configured by the use of a cell type and a profile for a second set of parameter values (e.g., configuration parameters). A second set of parameter values (e.g., configuration parameters) may be (e.g., more) dynamic in nature. For example, a WTRU's RLC channel configuration may use a legacy RRC configuration while a WTRU's RLF time (e.g., RLF timers) may use a profile or a cell type mechanism. The following may apply to a (e.g., any) WTRU with configuration mechanism(s) defined.

A WTRU may determine which mechanism to use to determine the value of a parameter (e.g., parameter value, configuration parameter value).

NW-signaled mechanism selection may be described.

In examples, a WTRU may receive mechanism(s) to be used for a (e.g., each) parameter from network signaling.

For example, a mechanism may be received from SIB signaling, and/or the mechanism may be cell specific.

For example, a WTRU may receive the mapping of parameter to mechanism in dedicated signaling (e.g., for the cases where mapping is configured per WTRU).

In examples, a WTRU may receive an indication of the mechanism to use for a (e.g., each) parameter. An indication may be a bit mask configuration value (e.g., a parameter mask), where a (e.g., each) bit in the bit mask represents a (e.g., specific) parameter value (e.g., configuration parameter value). For example, a value of ‘1’ may indicates that the WTRU may use a first mechanism to determine the configuration of the corresponding parameter, and a value of ‘0’ may indicate that the WTRU may use a second mechanism to determine the configuration of the corresponding parameter. For example, the WTRU may derive the parameter value (e.g., configuration parameter value) for which the received parameter mask is 0 (e.g., based on its WTRU profile and a cell type broadcast in SIB). In examples, for parameter value(s) (e.g., configuration parameter value(s)) for which the parameter mask is a ‘1’, the WTRU may determine the value of the parameter based on RRC signaling. In examples, if a parameter is not included in an RRC message (e.g., based on delta signaling), the WTRU may maintain the current value of the parameter (e.g., configuration parameter).

In examples, a WTRU may determine the mechanism based on the configuration elements included in a full configuration. For example, the WTRU may receive an RRC message signaled as a full configuration (e.g., full configuration flag included). For (e.g., any) RRC parameters included in the RRC message, the WTRU may determine a parameter to be configurable by RRC. In examples, for (e.g., any) parameters not included in the RRC message, the WTRU may determine a parameter to be configurable by profile and cell type. The WTRU may maintain a mapping of parameter value (e.g., configuration parameter value) to configuration mechanism between each reception of an RRC message indicating full configuration.

WTRU autonomous mechanism selection may be described.

In examples, the WTRU may determine its mechanism autonomously. Examples similar to those describing WTRU autonomous profile selection may be used for the WTRU to determine its configuration mechanism. For example, the WTRU may be (pre)configured or specified with a parameter mask for a WTRU determined factor (e.g., the WTRU may be (pre)configured or specified with a specific parameter mask for each of a specific WTRU determined factor, such as a measured RSRP, a WTRU speed, a WTRU location, and/or the like). For example, information transmitted by the cell (e.g., cell ID) may implicitly indicate a (pre)configured parameter mask (e.g., may implicitly indicate one of a number of (pre)configured parameter masks). For example, the WTRU may be configured with a list of parameter masks. The index of the relevant parameter mask for a cell may be determine by the WTRU from the cell ID (e.g., cell ID mod N, where N is a configured parameter). For example, based on the active services or QoS flows at the WTRU, the WTRU may determine the parameter mask.

A WTRU may signal the selected profile.

In examples, a WTRU that selects its profile, may (e.g., further) signal the selection to the network. The WTRU may include its selected profile in a message, such as, for example, an RRC message, a MAC CE, a physical channel signal, and/or the like. For example, a WTRU may signal a (e.g., change in) profile in a dedicated PUCCH resource. For example, a WTRU may signal its profile in a MAC CE.

A WTRU may (e.g., further) determine the mechanism and/or timing for indicating its change in profile based on if/whether the change in configuration resulting from a change in profile would affect its transmission. For example, a WTRU may be configured with a set of parameter value(s) (e.g., configuration parameter(s)) which impact the WTRU's transmissions. If a profile change determined at the WTRU would affect the WTRU's transmission parameters, the WTRU may indicate the selected profile in a first mechanism, otherwise, the WTRU may indicate the selected profile in a second mechanism.

The first mechanism to indicate the selected profile may include at least one of the following.

In examples, the WTRU may indicate the (e.g., new) selected profile prior to the configuration change caused by the change in profile.

In examples, the WTRU may indicate the (e.g., new) selected profile using a transmission performed using a default configuration. A default configuration may be configured to the WTRU in RRC signaling, or may be available in the SIB. A default configuration may be specified.

In examples, the WTRU may indicate the (e.g., new) selected profile using a transmission that is valid across profile(s) (e.g., that is valid across all profiles, such as a common resource, a common configuration, and/or the like).

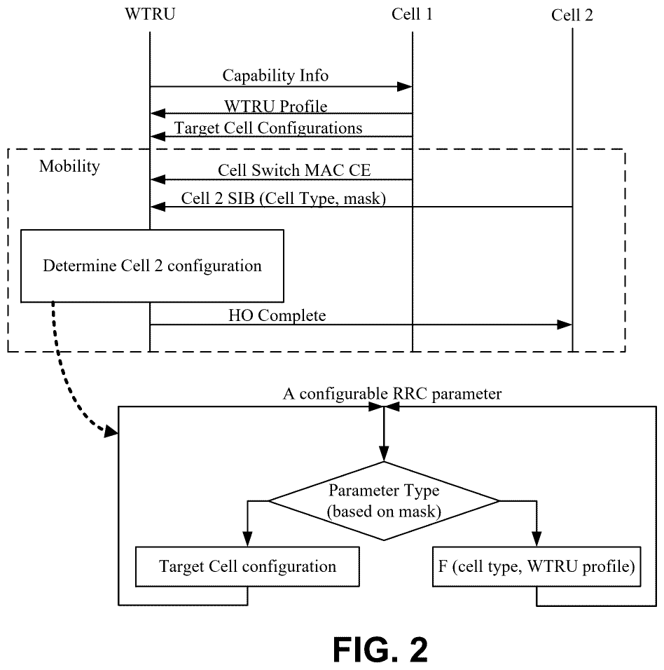

FIG. 2 is a block diagram illustrating an example solution associated with low overhead reconfiguration. As illustrated in FIG. 2,, a WTRU may start by transmitting capability information to the network (e.g.,, to cell 1, assumed to be the WTRU's serving cell). The WTRU may transmit the capability information using legacy mechanism(s).

A WTRU may (e.g., then) be provided with an RRC configuration. An RRC configuration may (e.g., further) provide the WTRU with a WTRU profile (e.g., a profile value or index). The network may derive the profile based on the WTRU's capability information. As part of the WTRU's RRC configuration, the WTRU may receive the RRC configurations for a candidate cell (e.g., for a number of candidate cells, e.g., target cell configurations). Target cell configurations may indicate the configuration value for a subset of parameters which are changeable by legacy way (e.g.,, via the RRC configuration).

The WTRU may receive a mobility command (e.g., a cell switch indication, for example in a MAC CE). The cell switch may indicate the cell ID to which the WTRU performs a handover. The WTRU (e.g., following the cell switch command), may determine a cell type and a parameter mask from the SIB of the target cell. Based on the cell type, parameter mask, previously configured WTRU profile and/or target cell configuration (e.g., for the cell in question) the WTRU may determine its configuration (e.g., in the target cell). For example, if a parameter is indicated in the mask to use a profile and a cell type, the WTRU may determine the value of that parameter based on a function of the profile and cell type (e.g., a specified table mapping cell type and profile to a parameter value (e.g., configuration parameter value)). If the mask indicates to use the RRC configuration, the value of the parameter may be derived from the target cell configuration.

Although features and elements described herein are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, NR or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed:

1. A wireless transmit/receive unit (WTRU) comprising:
a processor configured to:
determine a WTRU profile;
determine a cell type associated with a target cell;
determine a parameter mask, wherein the parameter mask indicates whether to determine a parameter value based on a reference configuration or based on a combination of the WTRU profile and the cell type;
on a condition that the parameter mask indicates to determine the parameter value based on a combination of the WTRU profile and the cell type, determine the parameter value based on the WTRU profile, the parameter mask, and the cell type; and
initiate, using the determined parameter value, one of a transmission associated with the target cell or a reception associated with the target cell.

2. The WTRU of claim 1, wherein the processor is further configured to:
receive configuration information comprising a plurality of parameter values, wherein each parameter value from the plurality of parameter values is associated with a respective WTRU profile and cell type pair, wherein the parameter value is further determined based on the configuration information.

3. The WTRU of claim 1, wherein the WTRU profile is determined based on one or more of data available for transmission, a cell measurement, a WTRU capability, a WTRU speed, or received configuration information indicating the WTRU profile.

4. The WTRU of claim 3, wherein the received configuration information is dedicated radio resource control (RRC) configuration information, and wherein the dedicated RRC configuration information further indicates one or more of RRC configuration information associated with operating in the target cell, a reference configuration, or candidate cell configuration information.

5. The WTRU of claim 1, wherein the parameter mask is determined based on one or more of a measurement, a WTRU speed, a WTRU location, an active service associated with the WTRU, a quality of service flow associated with the WTRU, or a received indication.

6. The WTRU of claim 1, wherein the cell type is determined based on one or more of an indicated value, an identity associated with target cell system information, a transmission property associated with the target cell, a transmission of a signal, or a determination of an absence of the signal.

7. The WTRU of claim 1, wherein the processor is further configured to:
receive a system information block (SIB) associated with the target cell, wherein the SIB indicates the parameter mask and the cell type associated with the target cell.

8. The WTRU of claim 1, wherein the parameter mask is a bit mask, wherein a bit in the bit mask indicates whether to determine the parameter value based on the reference configuration or based on the combination of the WTRU profile and the cell type.

9. The WTRU of claim 1, wherein the WTRU profile is one of a value or an index.

10. The WTRU of claim 1, wherein the parameter value is associated with one or more of a channel state information (CSI) configuration or a search space configuration.

11. A method comprising:
determining a wireless transmit/receive unit (WTRU) profile;
determining a cell type associated with a target cell;
determine a parameter mask, wherein the parameter mask indicates whether to determine a parameter value based on a reference configuration or based on a combination of the WTRU profile and the cell type;
on a condition that the parameter mask indicates to determine the parameter value based on a combination of the WTRU profile and the cell type, determining the parameter value based on the WTRU profile, the parameter mask, and the cell type; and
initiating, using the determined parameter value, one of a transmission associated with the target cell or a reception associated with the target cell.

12. The method of claim 11, wherein the method further comprises:
receiving configuration information comprising a plurality of parameter values, wherein each parameter value from the plurality of parameter values is associated with a respective WTRU profile and cell type pair, wherein the parameter value is further determined based on the configuration information.

13. The method of claim 11, wherein the WTRU profile is determined based on one or more of data available for transmission, a cell measurement, a WTRU capability, a WTRU speed, or received configuration information indicating the WTRU profile.

14. The method of claim 13, wherein the received configuration information is dedicated radio resource control (RRC) configuration information, and wherein the dedicated RRC configuration information further indicates one or more of RRC configuration information associated with operating in the target cell, a reference configuration, or candidate cell configuration information.

15. The method of claim 11, wherein the parameter mask is determined based on one or more of a measurement, a WTRU speed, a WTRU location, an active service associated with the WTRU, a quality of service flow associated with the WTRU, or a received indication.

16. The method of claim 11, wherein the cell type is determined based on one or more of an indicated value, an identity associated with target cell system information, a transmission property associated with the target cell, a transmission of a signal, or a determination of an absence of the signal.

17. The method of claim 11, wherein the method further comprises:
receiving a system information block (SIB) associated with the target cell, wherein the SIB indicates the parameter mask and the cell type associated with the target cell.

18. The method of claim 11, wherein the parameter mask is a bit mask, wherein a bit in the bit mask indicates whether to determine the parameter value based on the reference configuration or based on the combination of the WTRU profile and the cell type.

19. The method of claim 11, wherein the WTRU profile is one of a value or an index.

20. The method of claim 11, wherein the parameter value is associated with one or more of a channel state information (CSI) configuration or a search space configuration.
